(19) United States
(12) Patent Application Publication
(10) Pub. No.: US 2004/0200148 A1
(43) Pub. Date: Oct. 14, 2004

(54) Lightweight planting apparatus for aquatic plants

(76) Inventors: Brian Schuck, Charleston, SC (US); Richard J. Schuck, Jarrettsville, MD (US); Stuart Schuck, Mt. Pleasant, SC (US)

Correspondence Address: Royal W. Craig, Law Offices of Royal W. Craig, Suite 153, 10 N. Calvert Street, Baltimore, MD, 21202, US

(21) Appl. No.: 10/774,838

(22) Filed: Feb. 9, 2004

Related U.S. Application Data
(60) Provisional application No. 60/446,290, filed on Feb. 7, 2003.

(51) Int. Cl. A01G 9/02

(52) U.S. Cl. 47/84

(57) ABSTRACT

A device and method for use in growing, transporting and transplanting aquatic plants. The device includes an open web fibrous strip of water resistant material. When utilized in conjunction with a juvenile water lily or marginal plant, the material is configured as a coil around the roots of a single plant. When utilized in conjunction with “oxygenator” stems or bare root cuttings, the material is configured as a strip folded to enclose multiple cuttings/plants spaced at periodic intervals. Using the present invention, aquatic plant(s) are grown in a soil-less environment, making them lightweight for economically shipping via parcel post and exportable to all states and many foreign countries because they do not contain potentially contaminated soil. A plant grown in the present invention is fully developed and will quickly resume growing once planted in an end user's pond.

### CROSS-REFERENCE TO RELATED APPLICATIONS

The present application derives priority from U.S. Provisional Patent Application No. 60/446,290 for “LIGHTWEIGHT PLANTING SYSTEM FOR AQUATIC PLANTS”, filed: Feb. 7, 2003.

### BACKGROUND OF THE INVENTION

1. Field of the Invention

The present invention relates to aquatic gardening and, more particularly, to a means for facilitating (1) the rapid growth of an aquatic plant in an aquatic nursery, (2) the plant's transportation from the nursery to an end user, and (3) the planting of the aquatic plant in an end user's pond.

2. Description of the Background

Normal healthy growth of aquatic plants, such as marginal plants and water lilies, in ponds and the like contributes significantly to the quick establishment of a balanced, healthy pond environment by helping to shade out and control the growth of algae (by consuming the excess nutrients such as ammonia and nitrites found in ponds) and providing cover for any fish in the pond. Additionally, normal healthy grown of oxygenator plants soften the pond's appearance and maintain appropriate oxygen levels in the water while also contributing to nutrient reduction. On the other hand the humus substances generated by decomposed plant tissues detoxifies heavy metals within pond water. In summary, aquatic plants are valued pond inhabitants because they (1) protect fish by removing ammonia and metals from the water, (2) control algae, (3) stabilize the water's pH level, (4) increase biological activity within the pond, (5) oxygenate the water by removing carbon dioxide, and (6) prevent substrates from becoming toxic.

Traditionally, aquatic nurseries grow and transport aquatic plants in large pots using regular garden soil as a substrate. However, the traditional methods of growing aquatic plants in an aquatic nursery, transporting the plant from the nursery to an end user, and installing the plant in an end user's pond are beset with a number of problems. The specific nature of the problems vary with the type of aquatic plant involved.

For example, one type of aquatic plant is the water lily. The considerable weight of a potted water lily plant, grown to a size suitable for shipping, may limit the shipment modes and methods. Water lilies are normally grown in one- to two-gallon pots using regular garden soil as a substrate. The process of potting the water lily and then placing the potted plant in a water basin requires considerable manual effort, due to the weight of the soil. By the time the water lily has grown sufficiently and is thus ready for transportation to, or by, an end user, the overall weight of the potted plant has increased considerably because the soil has become saturated by the water. Due to an adequately watered potted water lily's considerable weight, the only practical and economically feasible method for shipment is via truck.

Mail order delivery of a water lily plant is only possible if the water lily is removed from the pot, trimmed of excessive leaves and roots, and shipped as a bare root tuber. However, mailing the water lily as a bare root tuber can damage the plant, resulting in a weakened plant that is slow to grow once it is planted in the end user's pond.

Additionally, transportation of foreign soil creates another problem. Specifically, many states and foreign countries will not allow a plant to cross into its borders if soil is present on the plant. This is due to impurities such as microbes and pests that may be present in the soil. Obviously, soil-less plants would avoid these prohibitions. Yet another problem with the use of soil is the presence of weed seeds. Without regular weeding, a labor intensive task, it is difficult to maintain the potted plant in a readily salable condition.

A second type of aquatic plant is a shallow water or marginal plant. Plants of this nature grow along the margin of a pond where the water is shallow. In this regard, they differ from water lilies which generally are grown in deeper water. However, in a manner similar to that for water lilies, they are normally grown in one- to two-gallon pots using regular garden soil as a substrate. Therefore, the issues outlined above regarding transportation, soil contamination, etc., apply equally to shallow water/marginal plants.

A third type of plant is the submerged aquatic or “oxygenator” plant. Plants of this type grow entirely, or almost completely, beneath the water's surface. The term “oxygenator” is associated with these plants because, during the process of photosynthesis, their leaves emit oxygen bubbles into the surrounding water column. The plants are typically sold as stem cuttings or bare root plants. As with the first two types of plants, their continued growth, once planted in an end user's pond, is slowed due to the fact that the cuttings/bareroot plants must regenerate roots and overcome the shock of transplantation into a new environment. While these aquatic plants are relatively inexpensive to grow, harvest, and ship via mail order, their survival rate between the harvesting and replanting processes can be problematic.

For example, stem cuttings are extremely perishable and a substantial percentage of them die during shipment, especially when the temperature of the surrounding environment exceeds 80° F. Another substantial percentage dies while in storage, either at a retail facility or an end user's home, prior to being displayed for sale or re-planted in an aquatic environment. When finally planted in an end user's pond, an additional percentage fails to survive the shock of transplantation, especially when placed in cloudy or murky water. In a cloudy/murky environment, the plants receive too little light and die. Given that these plants are often purchased by an end user that wants to clear the water in his/her pond, their's is an ironic fate.

To the best of the knowledge of the present inventors, up until now there has been no expedient way of facilitating the rapid growth of aquatic plants in an aquatic nursery, followed by the soil-less, mail order transportation of aquatic plants to end users, and the installation of the plants in the end users' ponds. Consequently, it would thus be greatly advantageous to provide a soil-less, transportation-enabling apparatus for aquatic plants that (1) significantly enhances the plants' probability of ultimate survival, (2) possesses a simple, yet scalable and reconfigurable, design fabricated of strong, lightweight materials, and (3) may be economically manufactured and sold to provide for widespread use.

### SUMMARY OF THE INVENTION

It is, therefore, the primary object of the present invention to provide an apparatus that facilitates the rapid growth, soil-less transportation, and ultimate replanting of a wide range of aquatic plants with a rapid resumption of normal growth patterns.

A further object of the present invention is to provide such an apparatus whereby a plant's root system may easily and readily attach itself.

Another object of the present invention is to provide such an apparatus whereby a plant's root system may pass through the apparatus to a planting media as well as attach to the apparatus.

Still another object of the present invention is to provide an apparatus that possesses a simple, yet scalable and reconfigurable, design.

It is another object of the present invention to provide an apparatus that is fabricated of lightweight materials.

An additional object of the present invention is to provide an apparatus that is inexpensive to manufacture and sell to provide for widespread use.

According to the present invention, the above-described and other objects are accomplished using a lightweight planting material for aquatic plants typically comprising an open web, polyester fiber material that is water resistant to maximize its durability in aquatic environments. The material possesses a simple, yet scalable and reconfigurable, design that may be economically manufactured and sold to provide for widespread use. In the first embodiment of the present invention, when utilized in conjunction with a juvenile water lily or a marginal plant, the material is configured as a coil wrapped around the roots of the plant (the roots being at the center of the coil). Hereinafter, this coil/plant combination is referred to as a “pod”. In the second embodiment of the present invention, when utilized in conjunction with an “oxygenator” stem or bare root cutting, the material is configured as a strip folded in two (forming two layers) with one or more cuttings/plant stems spaced apart at regular intervals enclosed between the two layers (hereinafter, this folded strip/plant combination is referred to as a “reef”). Typically, a reef is held together by one or more UV-resistant cable ties and includes some amount of lead weighting, or other suitable ballast, to offset the natural buoyancy of the material and cutting/plant. Pods and reefs are light in overall weight, yet sturdy enough to stand upright without a pot or other means of support. These characteristics facilitate their display for sale and eventual installation in an end user's pond.

In use, a pod is placed in a nursery pot that is filled with 1″ of calcined clay and a measured amount of fertilizer. The potted pod is placed into a water basin where the plant quickly roots out through the material and attaches to the calcined clay substrate. The potted pod requires little or no weeding because the material, the calcined clay substrate, and the fertilizer contain no weed seeds prior to placement in the nursery pot. When a plant is fully-developed, the pod is removed from the pot, washed free of all clay and fertilizer, and drained of all excess water before being placed back into a empty clean pot. The clean soil-less pod and pot unit weighs is lightweight and easily shipped via parcel post. Additionally, the pod is accepted in all states and many foreign countries as it does not contain potentially contaminated soil. Once received by the end user, the pond is transplanted into the end user's pond and quickly resumes normal growth.

In use, a reef is placed into a water basin that has been lined with a 1″ layer of calcined clay and fertilizer. A lead weighting, or other suitable ballast, holds the reef at the bottom of the water basin allowing the plant to quickly root out through the material and into the clay/fertilizer layer. When a plant is to be shipped to an end user, the reef is removed from the basin, washed free of all clay and fertilizer, and drained of all excess water. The reef is light weight and easily shipped via parcel post. As with the lily and marginal plant pods, the reef is soil-free and is a fully developed plant that will quickly resume growing once planted in an end user's pond.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a close-up perspective view of a planting material 10 according to the preferred embodiment of the present invention.

FIG. 2 is a side cross-sectional view of the planting material 10 of FIG. 1 shown in use in a “pod” 15 configuration.

FIG. 3 is a top view medial cross-section of the “pod” 15 configuration as in FIG. 2.

FIG. 4 is a cross-section view of the planting material 10 of FIG. 1 shown in use in a “reef” 65 configuration.

FIG. 5 is a perspective view of the reef 65.

### DETAILED DESCRIPTION OF THE PREFERRED EMBODIMENTS

The present invention is a method and apparatus that facilitates the rapid growth, soil-less transportation, and transplanting of a wide range of aquatic plants. The apparatus generally comprises a container containing a mixture of potting media and fertilizer covering the bottom surface area, and a plant having a stem that is enclosed in an open web fibrous material, either in a pod configuration in which the material is coiled around the roots of a single plant, or a reef configuration in which the material is folded and one or more plants are enclosed between the layers of the fold. In either case, plant(s) wrapped in a fibrous web are placed upright and vertical inside the container on top of the mixture of potting media and fertilizer. The wrapped plant is supplied with water and is grown in the container until fully developed. Once fully grown the fully developed wrapped plant is removed from the container, cleaned, drained, boxed and shipped to an end user.

The apparatus and method of the present invention provide for the growth of aquatic plants in a fibrous planting material 10 instead of garden soil.

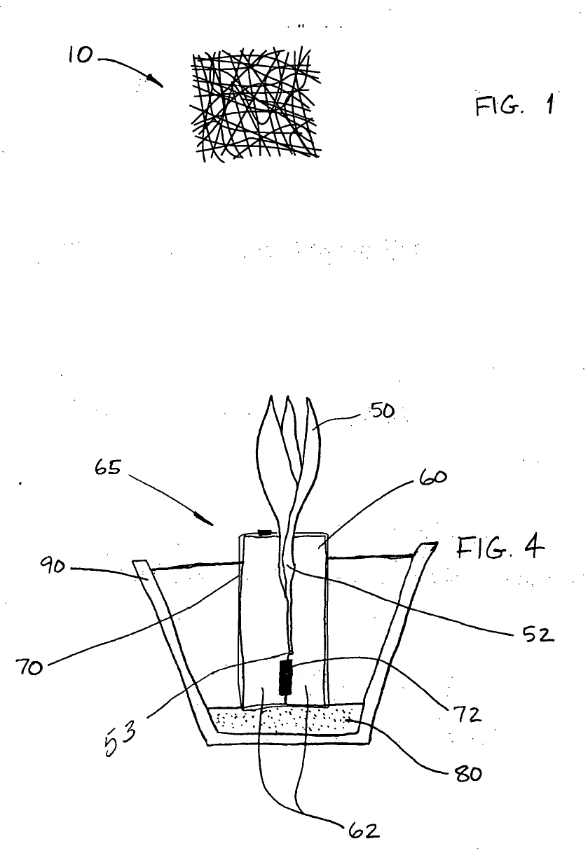

FIG. 1 is a perspective view of the planting material 10 according to the preferred embodiment of the present invention. The planting material 10 is preferably lightweight and comprised of a non-woven, open and random web of polyester blend fibers. Additionally, the material 10 is water resistant to maximize its durability in aquatic environments and pliable such that it may be wrapped into a coil or folded into a multi-layered configuration. The material 10 further possesses a simple, yet scalable and reconfigurable, design that is readily commercially available or may be economically manufactured and sold to provide for economical widespread use. As described below, the open web construction promotes rapid root growth, and the material 10 reduces the costs associated with growing, transporting, and re-planting aquatic plants while increasing their probability of ultimate survival. Those skilled in the art will recognize that in addition to the preferred open and random web polyester blend fibers, other open web fibrous filter or planting materials, comprised of woven and/or natural fibers, will be suitable for the purpose of the present invention.

One example of a suitable material 10 is the POLY-FLO filter media commercially available from a number of distributers and retailers, including Americo Manufacturing of Acworth, Ga. and www.pondliners.com (product no. FM56JC). This material is available in rolls of a variety of lengths, widths, and thicknesses. Another example of a suitable material 10 is SmartGrow (™), which is a patented manufactured planting material made of 100% natural, biodegradable hair fiber having some nutritional properties.

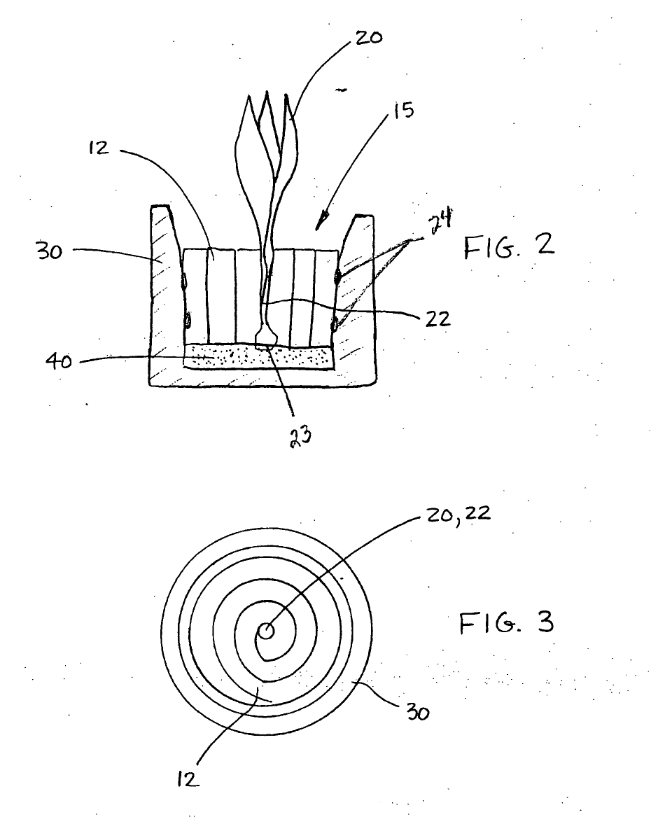

The apparatus and method of the present invention, using material 10, are described for use with two different preferred embodiments, depending on the nature of the aquatic plant to be grown, transported, and transplanted. The first embodiment, depicted in FIGS. 2 and 3 combined is used in conjunction with water lilies and marginal plants. The second embodiment, depicted in FIG. 4 is used in conjunction with “oxygenator” stems or bare root cuttings.

As shown in FIGS. 2 and 3 combined, when utilized in conjunction with a juvenile water lily or a marginal plant 20, the planting material 10 is configured as a coil 12 wrapped around the roots 22 of the plant 20 with the plant 20 being placed at the center of the coil 12. Hereinafter, this coil 12/plant 20 combination is referred to as a “pod” 15. In this first embodiment, the coil 12 of wrapping material 10 is comprised of an approximately 1″ to 1.5″ thick strip of the material 10 with a width and length of approximately 2″ to 4″ and 18″ to 36″, respectively. However, the length and width of the strip will vary depending upon the size of the plant 20 and the size of the pot 30 that will hold it. The width of the strip needs to be sufficient to cover and enclose the plant's roots and the length sufficient to create a coil to fills pot 30. Thus, when coiled around the plant, material 10 will provide adequate protection and support. Optionally, one or more ties 24, such as UV-resistant cable ties, may be secured around the coil 12 to hold the coil 12 together.

In order to grow the juvenile plant 20 in the pod 15, the pod 15 is placed in a nursery pot 30 with a inner diameter large enough to accommodate the pod 15 (i.e. 6″ for the preferred embodiment) in which the bottom is covered with an approximately 1″ thick layer of a mixture of a potting media and fertilizer 40. The proportional amounts of potting media and fertilizer of layer 40 may vary depending on the nutritional requirements of the particular plant. For the purposes of the present invention, the preferred layer 40 is a soil-less mixture containing measured amounts of calcined clay and fertilizer. Calcined clay is preferable due to its high cation exchange capability that attracts and absorbs nutrients, such as non-leachable forms of any available ions of ammonium, potassium, calcium, and magnesium, that may then be readily used by a plant 20 rooted in layer 40. These nutrients, as well as the fact that the growing conditions in the pod are aerobic as opposed to the anaerobic conditions of water-logged garden soil, facilitate rapid root and plant 20 growth. To further facilitate rapid root and plant 20 growth, the pot 30, containing the potting media layer 40 and the pod 15, is placed into a water basin where the plant 20 quickly roots out through the coil 12 and attaches to the potting media layer 40. This rapid growth of the plant 20 decreases the time required to produce a filly developed plant 20 ready for sale and/or delivery to an end user. Little or no additional maintenance of the pod 15 is required (i.e. weeding) because there are no existing weed seeds in the coil 12, plant 20, and potting media layer 40 prior to placement in the nursery pot 30.

In order to transport a plant 20 (i.e. ship the plant 20 to an end user), the pod 15 is removed from the pot 30, washed free of all potting media and fertilizer, and is drained of all excess water. The clean/drained pod 15 is then placed into a cleaned (by removing the potting media layer 40 and washing) or new empty pot 30. In this first embodiment, as described herein, the combined weight of the pod 15 placed in the empty pot 30 (a 1 gal. pot) is approximately one pound. This weight is substantially less than the 10 pound weight of the same plant potted in a one gallon pot with soil and water. The one-pound unit is easily shipped via parcel post to the end user. Additionally, the pod 15 is accepted in all states and many foreign countries as it does not contain any potentially contaminated soil.

The pod 15, received by the end user, is also a fully developed plant 20 that once transplanted will quickly resume growing once planted in an end user's pond.

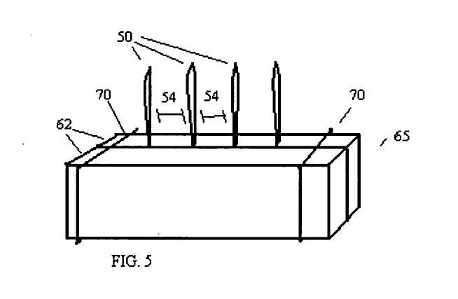

As shown in FIGS. 4 and 5 combined, when utilized in conjunction with “oxygenator” stems or bare root cuttings of plants 50, the planting material 10 (the same material as shown in FIG. 1 and discussed above) is configured as a strip 60 in which the length of the strip is folded in half creating two layers 62 with the stems 52, including the cut ends 53, of multiple cuttings 50 are enclosed between the two layers 62 at periodic intervals. Hereinafter, this folded strip 60/plant 50 combination is referred to as a “reef” 65. In this second embodiment of the present invention, a reef 65 may be created by folding the length of an approximately 1″ to 1.5″ thick, 2″ to 4″ wide and up to 36″ long strip 60 of the fibrous material 10 in half around the stems 52 a plurality of plants 50, so that opposing sides of the strip are paired and perpendicular to the stems 52 that are enclosed at periodic intervals 54 (i.e. every 1 inch) within. The width of the strip should be sufficient to securely hold the stem of the plant. The length of the strip is variable and can be short or long depending on the number of plants 50 to be contained within the reef 65 and the interval 54. However, the reef 65 should not be so long that it creates a shipping or deployment problem (i.e. no longer than approximately 18 inches). Typically, a reef 65 is held together by one or more ties 70, such as UV-resistant cable ties, secured around the width. The reef 65 further includes some amount of lead weighting or other suitable ballast 72 located at or near the cut ends 53 of plants 50, either enclosed within folded strip 60 or attached to the outside of folded strip 60. The weighting 72 is for offsetting the natural buoyancy of reef 65.

In order to grow plants 50, the reef 65 is placed into a water basin 90 in which the bottom has been lined with an approximately 1″ layer of a potting media with fertilizer 80. The above discussion regarding the potting media layer 40 is applicable to potting media layer 80. The weighting 72 holds the reef 65 at the bottom of the water basin 90. Additionally, the weighting 72 as well as the support provided to the stem 52 by secured folded strip 60 encourages the plant 50 to remain in a vertical position and to quickly root out through the material 10 into the potting media layer 80.

In order to transport a developed plant(s) 50 (i.e. ship the plant(s) 50 to an end user), the reef 65 is removed from the basin 90, washed free of all potting media and fertilizer, and drained of all excess water. The cleaned/drained reef 65 is light weight and easily boxed and shipped via parcel post. As with the lily and marginal plant pods 15 (see FIG. 2), the fully-developed plant(s) 50 of reef 65 are soil-free and will quickly resume growing once transplanted into an end user's pond. The fully developed nature of a plant 50 within a reef 65 significantly increases the plant's odds of surviving transportation and transplantation.

The sooner healthy aquatic plant life is firmly established in a pond, the sooner the pond environment will experience the benefits of the aquatic plant life. Specifically, the benefits include (1) protection of fish by removing ammonia and metals from the water, (2) control of algae, (3) stabilization of water pH level, (4) increased biological activity within the pond, (5) oxygenation of the water by removing carbon dioxide, and (6) prevention of substrates from becoming toxic. Therefore, pond builders/owners will appreciate the rapid resumption of normal plant growth patterns experienced by the fully-developed plants (20 or 50) transplanted from the pods 15 and reefs 65 of the present invention into end users' ponds.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A device for growing and transporting plants for transplantation, said article comprising:
a container, containing a mixture of potting media covering the bottom surface area; and
an open web fibrous material enveloping and adhered to lower end of a plant including the roots and/or the stem of a plant, said material and enveloped plant being placed upright and vertical inside said container on top of said mixture of potting media, and said enveloped plant being supplied with water and grown in said container until fully developed;
whereby said fully developed wrapped plant is removed from said container cleaned, drained, boxed and shipped to an end user.

2. The device according to claim 1, wherein said potting media is a soil-less potting media.

3. The device according to claim 2, wherein said soil-less potting media is comprised of calcined clay.

4. The device according to claim 1, wherein the fibrous material is comprised of a strip of non-woven fibers that are sufficiently loose to allow plant roots to attach to and grow there-through.

5. The device according to claim 4, wherein said strip of fibrous material is comprised of synthetic fibers.

6. The device according to claim 5, wherein said strip of fibrous material is comprised of polyester fibers.

7. The device according to claim 4, wherein said strip of fibrous material is comprised of natural fibers.

8. The device according to claim 7, wherein said strip of fibrous material is comprised of human hair.

9. The device according to claim 1, wherein said plurality of plants are aquatic plants.

10. The device according to claim 9, wherein said fibrous material envelopes and adheres to the roots of one aquatic plant and said aquatic plant is selected from the group comprising water lily tubers and marginal plant cuttings; said plant having either a root or a cut end; and said fibrous material is a strip of material coiled around the roots of said plant to form a pod such that the plant roots are enveloped centrally in said pod.

11. The device according to claim 10, wherein said coil is secured by ties.

12. The device according to claim 11, wherein said ties are UV-resistant cable ties.

13. The device according to claim 12, wherein said container is a round pot; and said coil covers the roots of the plant and has a diameter approximately equal to the inner diameter of said pot.

14. The device according to claim 12, wherein the dimensions of said strip are approximately equal to 1 to 1.5 inches by 2 to 4 inches by 18 to 36 inches.

15. The device according to claim 9, wherein said aquatic plant is selected from the group comprising oxygenator stems and bare root cuttings and has a cut end, and wherein the cut ends of a plurality of said aquatic plants are periodically spaced within, oriented perpendicular to and enveloped between two layers of said fibrous material; said layers secured together by ties; and said container comprises a basin filled with water.

16. The device according to claim 15, wherein said two layers of said fibrous material are formed by folding the length of a strip of said fibrous material in half.

17. The device according to claim 16, further comprising a weight attached to said folded strip proximate the cut ends of the plant stems for keeping the cut ends of the plant stems at the bottom of the water basin.

18. The device according to claim 17, wherein said strip has dimensions of approximately 1″ to 1.5″ thick, 2″ to 4″ wide and up to 36″.

19. The device according to claim 15, wherein said ties are UV-resistant cable ties.

20. A method for growing, transporting and transplanting plants, said method comprising:
Enveloping the lower end of a plant within an open web fibrous material;
filling a container with a mixture of potting media and fertilizer such that the bottom of the container is covered with said mixture;
placing said enveloped plant upright and vertical in a container and providing said plant with water such that said plant is allowed to grow and establish roots in said potting media;
once a plant is fully developed, removing said enveloped plant from said potting media and said container;
cleaning, draining and boxing said enveloped plant;
transporting said enveloped fully developed plant soilless to an end user; and
and transplanting said plant.

21. The method according to claim 20, whereby said plant is an aquatic plant and said step of transplanting said plant comprises planting said plant into an end user's pond.

22. The method according to claim 21, wherein said aquatic plant is selected from the group comprised of water lily tubers and marginal plant cuttings and has a root or cut end; and further wherein said step of enveloping the lower end of a plant in an open webbed fibrous material is further comprised of wrapping a strip of said fibrous material around the roots of said plant in a coil forming a pod such that the plant stem is contained in the center of the pod.

22. The method according to claim 21, wherein said container is a potting container and said step of providing said plant with water such that said plant is allowed to grow and establish roots in said potting media further comprises placing said potting container in a water basin.

23. The method according to claim 22, wherein said step of cleaning, draining and boxing said wrapped plant is further comprised of placing the cleaned and drained wrapped plant into a clean potting container prior to boxing.

24. The method according to claim 21, wherein said plants are selected from the group comprising oxygenator stems and bare root cuttings and said step of enveloping the lower end of a plant within an open web fibrous material, further comprises securing a plurality of said plants spaced at periodic intervals between two layers of said fibrous material.
